(19) United States
(12) Patent Application Publication
(10) Pub. No.: US 2002/0140147 A1
(43) Pub. Date: Oct. 3, 2002

(54) Computer hardware test stand

(75) Inventors: Yvetta D. Pols Sandhu, Winchester, MA (US); William A. Izzicupo, Bedford, NH (US); Ronald R. Boudreau, Boylston, MA (US)

Correspondence Address: LAHIVE & COCKFIELD, 28 STATE STREET, BOSTON, MA, 02109, US

(73) Assignee: Sun Microsystems, Inc.

(21) Appl. No.: 09/819,145

(22) Filed: Mar. 27, 2001

(51) Int. Cl. B25B 1/00

(52) U.S. Cl. 269/16

(57) ABSTRACT

A test stand for testing computer hardware components is provided. The test stand has a base structure. A first support arm mounts to the base structure. The first support arm has one or more apertures disposed therein to enable airflow through the support arm to avoid airflow hindrance of cooling fans during operation of the subject internal computer hardware components and when the test stand is in certain positions. A second support arm also mounts to the base structure. The second support arm has a rotation mechanism mounted therein. A support bracket for supporting the test subject computer hardware components extends between the first support arm and the second support arm. The support bracket is in communication with the rotation mechanism, such that the rotation mechanism controls and enables the rotation of the support bracket through a predetermined rotational degree range.

### FIELD OF THE INVENTION

The invention relates to a hardware test stand, and more particularly to a test stand suitable for providing complete access to computer hardware components while those components are under development, for example, in a laboratory setting.

### BACKGROUND OF THE INVENTION

Manufacturers today are continually upgrading and improving existing computer hardware systems. At certain times, and under certain circumstances in the product development cycle of these computer hardware systems, it is necessary for engineering personnel to have fall access to PC boards, and other internal computer hardware components, for testing and probing. Metal or plastic encasements typically protect and support the internal computer hardware components in the finished computer product.

However, having such encasements surround the internal computer hardware components while they are still under development substantially hinders the testing and probing access required by the engineers. The specific arrangement of the internal computer hardware components, in addition, can vary substantially between different computer systems. The arrangement can also vary from the initial design or concept, to a laboratory design, to a final manufactured product. If there are different arrangements, and/or different stages of arrangements, the ability to gain access to all portions of the components is often compromised. Access is compromised because it is difficult to support a structure undergoing periodic structural changes, or to support different structures, with the same or similar devices.

It is desirable to have the ability to set up and support the internal computer hardware components in manner that is similar or the same to the internal set up of the components within a final encased assembly. However, it is undesirable to use the complete encased assembly during development, because the assembly blocks access to the internal computer hardware components and hinders the necessary testing and probing actions. The internal computer hardware components must further be able to maintain complete and normal functionality. It is additionally desirable for the testing and probing processes carried out by engineers, or other users, to be generally ergonomic, and for the testing and probing process to be relatively comfortable for repeated and extended periods of probing and testing by the engineers or users.

### SUMMARY OF THE INVENTION

There exists in the art a need for a test stand for testing computer hardware components that provides full access to internal computer hardware components for testing and probing in an ergonomically appeasing manner. There is a further need for the test stand to feature pivotable access to the computer hardware components, and be relatively easy to use.

A test stand for testing computer hardware components in accordance with one example embodiment of the present invention has a base structure. A first support arm mounts to the base structure. The first support arm has one or more apertures disposed therein to enable airflow through the support arm. The airflow promotes cooling of the subject internal computer hardware components during operation when the test stand is in certain positions. A second support arm also mounts to the base structure. The second support arm has a rotation mechanism mounted therein. A support bracket for supporting the test subject computer hardware components extends between the first support arm and the second support arm. The support bracket is in communication with the rotation mechanism, such that the rotation mechanism controls and enables the rotation of the support bracket through a predetermined rotational degree range.

The base structure, in accordance with one aspect of the present invention, includes a generally box-shape structure for storing a selection of computer accessories.

The rotation mechanism, in accordance with further aspects of the present invention, can be a crank mechanism, a stepper motor, or the like. The crank mechanism or stepper motor, in each instance, couple with a gear train in communication with the support bracket. Rotation of the crank or the stepper motor causes rotation of the various gears of the gear train and subsequent rotation of the support bracket about a pivot axis.

The rotation mechanism, in accordance with another aspect of the present invention, includes a locking mechanism for locking the support bracket into a desired rotational position.

The test stand, in accordance with a further aspect of the present invention, can rotate the support bracket and any computer hardware attached thereto through a degree range anywhere between 0 degrees to 360 degrees, depending on external factors such as, e.g., electrical wire connections to the hardware components potentially wrapping around the entire structure if rotated through 360 degrees.

### BRIEF DESCRIPTION OF THE DRAWINGS

The aforementioned features and advantages, and other features and aspects of the present invention, will become better understood with regard to the following description and accompanying drawings, wherein:

FIG. 1 is a perspective view of a test stand according to one embodiment of the present invention;

FIG. 1A is a schematic illustration of a gear train according to one embodiment of the present invention;

FIG. 2 is a perspective view of the test stand of FIG. 1 according to one embodiment of the present invention;

FIG. 3 is a perspective view of the test stand with computer components mounted thereon according to one aspect of the present invention; and

FIG. 4 is a perspective view of the test stand of FIG. 3 according to another aspect of the present invention.

### DETAILED DESCRIPTION OF THE INVENTION

The present invention generally relates to a computer hardware test stand. The test stand allows engineering personnel to access all areas of the test subject computer components while the components are functioning. The test stand includes a support bracket into which the computer hardware components slide. The support bracket pivots about an axis between two support arms on either side of the support bracket. A rotation mechanism on one support arm enables the rotation of the computer hardware components. A locking mechanism allows the user to secure the support bracket in a specific location so that a user can work on any portion of the computer hardware components. Fans can mount on portions of the computer hardware components to cool the components while in use, and airflow apertures provided on one or both of the support arms promote airflow for cooling under certain circumstances. Cable routing features, in addition, provide for clean cable routing throughout the test stand. The ergonomic features of the test stand design, including the ability to easily view all portions of the components by simply rotating the components within the stand, reduce back strain on users/engineers probing the computer hardware components.

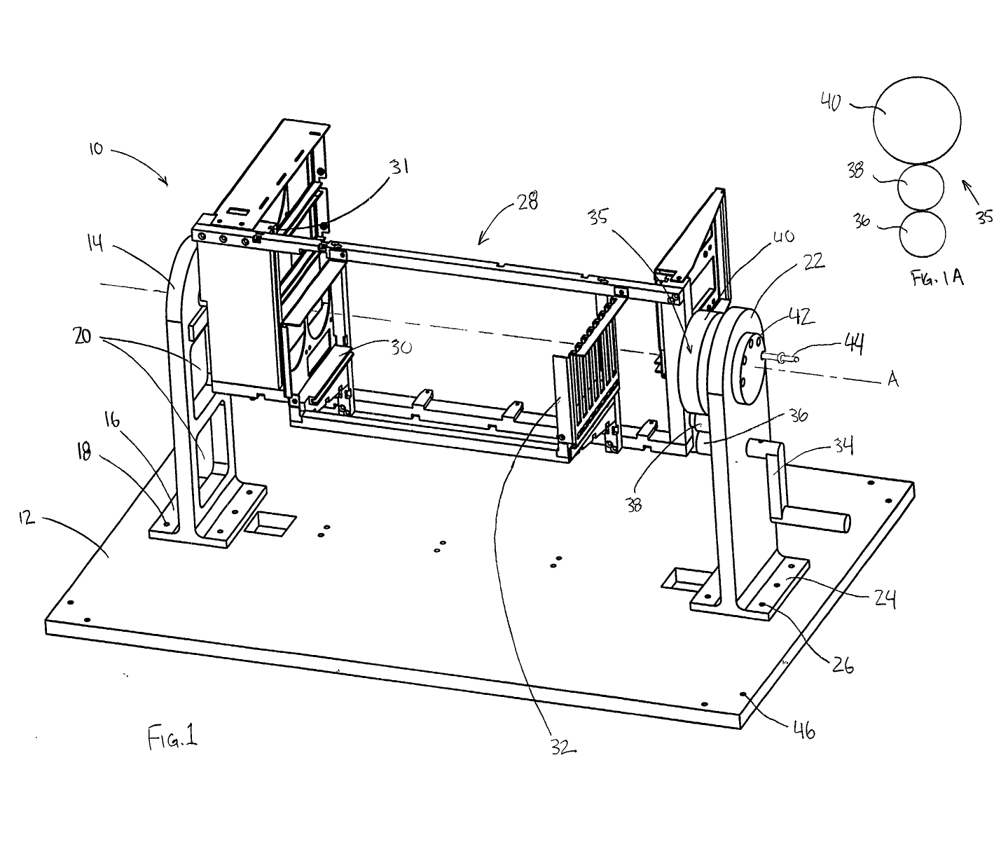

FIGS. 1 through 4, wherein like reference numbers designate like parts throughout, illustrate an example embodiment of a hardware test stand according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

FIG. 1 illustrates a perspective view of a test stand 10 according to one aspect of the present invention. The test stand 10 includes a base 12 upon which a first support arm 14 mounts. Any number of different materials such as, e.g., metal, wood, plastic, composite, and the like, can form the base 12, if the material has sufficient strength to support the test stand 10 and any components placed in the test stand 10 or on the base 12. It is also possible to cover the base 12 with an additional surface having specific properties, such as, e.g., a gripping rubber surface, a padded foam surface, or a Teflon® non-stick surface, as desired. The base 12 can additionally include added support structures, or braces, to support particularly heavy components, and the like, and be supported by a plurality of feet, legs, and the like.

The first support arm 14 has its own base 16 with a plurality of mounting apertures 18 disposed at predetermined locations. The base 16 of the first support arm 14 mounts to the base 12 of the test stand 10 through use of the mounting apertures 18 (e.g., through use of fasteners, screws, nails, rivets, connectors, and the like). Alternatively, the first support arm 14 can mount to the base 12 by any number of different means as anticipated by one of ordinary skill in the art, such as welding, gluing, clamping, fastening, and the like, or even through use of gravity by resting on top of the base 12. The first support arm 14 also includes two airflow apertures 20, which enable airflow through the support arm promoted by one or more fans, as detailed at a later point herein.

The test stand 10 further includes a second support arm 22 having a base 24 with mounting apertures 26 similar to those of the first support arm 14. Again, the second support arm 22 mounts to the base 12 through use of the mounting apertures 26. Alternatively, the second support arm 22 can mount to the base 12 using any number of different mechanisms or materials as anticipated by one of ordinary skill in the art, such as welding, gluing, clamping, fastening, and the like, or even through use of gravity by resting on top of the base. In addition, there can be any number from one, to a plurality, of support arms on either side of a support bracket 28.

The second support arm 22, according to one embodiment, further includes a rotation mechanism in the form of a crank handle 34 coupled with a gear train 35. The gear train 35 includes a first gear 36, a second gear 38, and a third gear 40. The function of the crank handle 34 in combination with each of the gears 36, 38, and 40, is to rotate the support bracket 28. The gear train 35 aids in this function as described in further detail below. The gear train 35 comprises a number of different gear combinations and gear tooth numbers for each gear, based on the desired relationship between input rotation and output rotation as well understood by one of ordinary skill in the art.

The support bracket 28 extends and pivotally mounts between the first support arm 14 and the second support arm 22. The support bracket 28 rotates or pivots about the axis A as shown in FIG. 1. The support bracket 28 includes a PCI I/O board bracket 30, a motherboard bracket 31, and a PCI card bracket 32, which are illustrative identifiers according to one embodiment of the present invention. The support bracket 28 can be in any number of possible configurations for supporting the specific piece or pieces of test subject computer hardware. There can be a single bracket, or multiple brackets, and each bracket can be adjustable or specific to a particular piece of test subject computer hardware. Further, to clarify, the brackets do not need to be PCI I/O board brackets 30, motherboard brackets 31, and PCI card brackets 32, but can be brackets identified by other names, and useful for holding other types of boards and/or computer hardware components.

The motherboard bracket 31, in this instance, supports a motherboard 51. The motherboard 51 slides into the motherboard bracket 31 and a number of possible fasteners, such as screws, hold the motherboard 51 in place. The support bracket 28 further includes the PCI I/O board bracket 30. A PCI I/O board 50 slidably inserts into the PCI I/O board bracket 30 according the illustrated embodiment of the present invention. Likewise, a number of fasteners, such as screws, hold the PCI I/O board 50 in place. A PCI card 52 then slides into the PCI I/O board 50 and the PCI card bracket 32. It should be noted that the PCI I/O board 50 and PCI card 52 are merely examples of types of boards that are illustrative of test subject computer hardware able to insert into one or more of the various brackets of the present invention.

The second support arm 22 further includes a locking apparatus in the form of a plurality of locking apertures 42 through which a pin 44 can insert. The locking apertures 42 pass completely through the second support arm 22 to intersect with similarly situated apertures (not shown) within an end of the support bracket 28 (the apertures can pass first through a gear of the gear train 35, depending on the particular arrangement). As the support bracket 28 rotates or pivots, the various apertures within the support bracket 28 align with the locking apertures 42 in the support arm 22. When the engineer/user positions the support bracket 28 in a desired position, one or more of the locking apertures 42 lines up with the apertures in the support bracket 28. The pin 44 inserts through one of the locking apertures 42 and into whichever aperture on the support bracket 28 that lines up with the particular locking aperture 42. The pin 44 thus locks the support bracket 28 in place until the pin 44 is removed.

There can be any number of different locking mechanisms to hold the support bracket 28 in desired positions as understood by one of ordinary skill in the art. There can be, for example, a ratcheting gear assembly to allow rotation in one direction, but not the other. There can be a double ratcheting gear assembly allowing the user to choose which direction the support bracket 28 can pivot, and which direction is locked. The different locking mechanisms can further include devices such as caliper clamps on a disc mounted with the gear assembly, brake pads applying friction forces against gear rotation, tying off of the support bracket 28 to prevent rotation, and the like.

All or a majority of the test stand 10 has components made of machined aluminum, according to one aspect of the present invention. However, the test stand 10 components can be made of any number of different materials, such as other types of metal, wood, composite, plastics, and the like, so long as the resulting structure can properly support the particular component or components being tested.

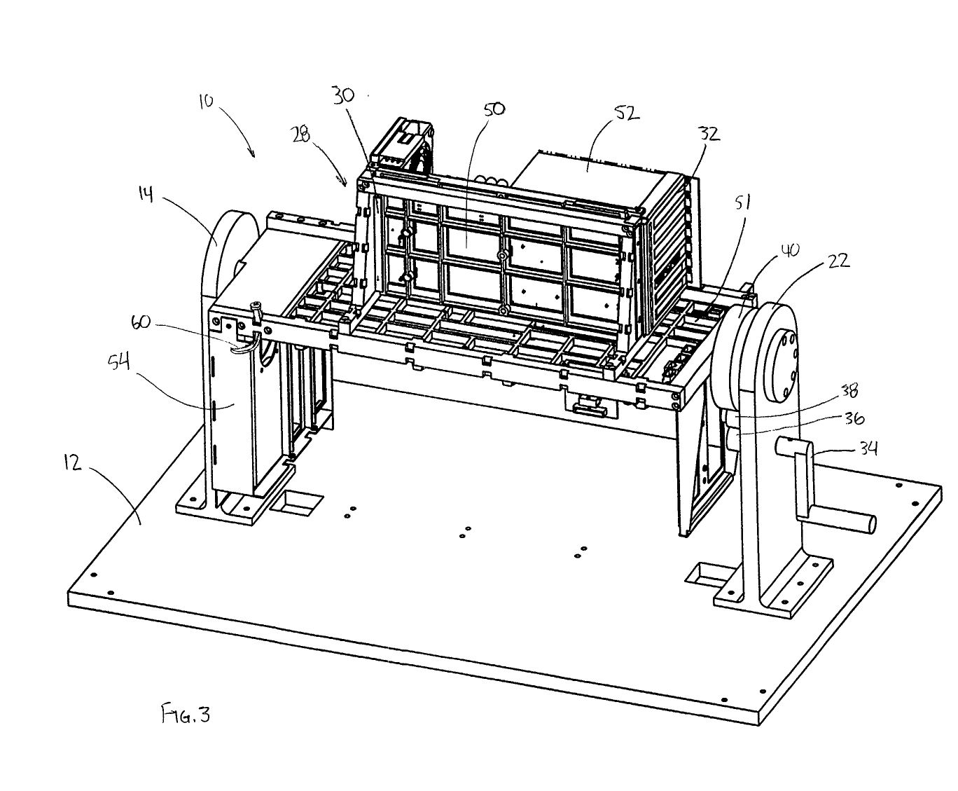

In operation, the motherboard 51, the PCI I/O board 50, and one or more PCI cards 52 insert into the motherboard bracket 31, the PCI I/O board bracket 30, and the PCI I/O board 50 respectively. Various electrical and digital lines connect to the motherboard 51, the PCI I/O board 50, and the PCI cards 52. A series of cable ties 60, fed through cable routing features 62, support and organize the wires and cables (not shown) (see FIG. 3).

Users can connect and activate or power-up the motherboard 51, the PCI I/O board 50, and the PCI card or cards 52 as desired. If a user desires to gain access to various portions of the motherboard 51, the PCI I/O board 50, or the PCI cards 52 the user can rotate the crank handle 34, which in turn rotates each of the gears 36, 38, and 40. This rotates the support bracket 28 containing the motherboard 51, the PCI I/O board 50, and the PCI cards 52.

If the user rotates the crank handle 34 in a clockwise direction, given the particular gear train 35 illustrated (see FIG. 1A), the support bracket 28 and the components mounted thereon will also rotate in the clockwise direction. If the user rotates the crank handle 34 in the counterclockwise direction, the support bracket 28 and the components mounted thereon will likewise rotate in a counterclockwise direction.

The rotation mechanism in the form of the crank handle 34 and the gears 36, 38, and 40, (illustrated in FIGS. 1 and 1A) benefits from a minor gear expansion, which allows the user to make minute adjustments to the position of the support bracket 28. A first gear 36 and a second gear 38 have a similar, or same, number of gear teeth, such that the gear ratio between the first gear 36 and the second gear 38 is approximately one. The second gear 38 and the third gear 40 then differ in gear tooth count, such that the gear ratio between each of the second gear 38 and the third gear 40 is approximately four. Thus if a user rotates the crank handle 34 in a complete rotation of 360 degrees, the support bracket 28 will rotate in the same direction as the crank handle, but only through 90 degrees of rotation. This combination of gears and gear teeth, as previously mentioned, is merely one example embodiment and can be modified to produce different input and output characteristics, as understood by one of ordinary skill in the art.

Once the user positions the support bracket 28 in a desired location, the user can utilize the locking mechanism in the form of the locking aperture 42 and the pin 44, or an alternate locking arrangement. The user inserts the pin 44 into the locking aperture 42, which extends through the second support arm 22 to apertures in the third gear 40 (not shown), or the support bracket 28. The pin 44 thus locks the support bracket 28 in place.

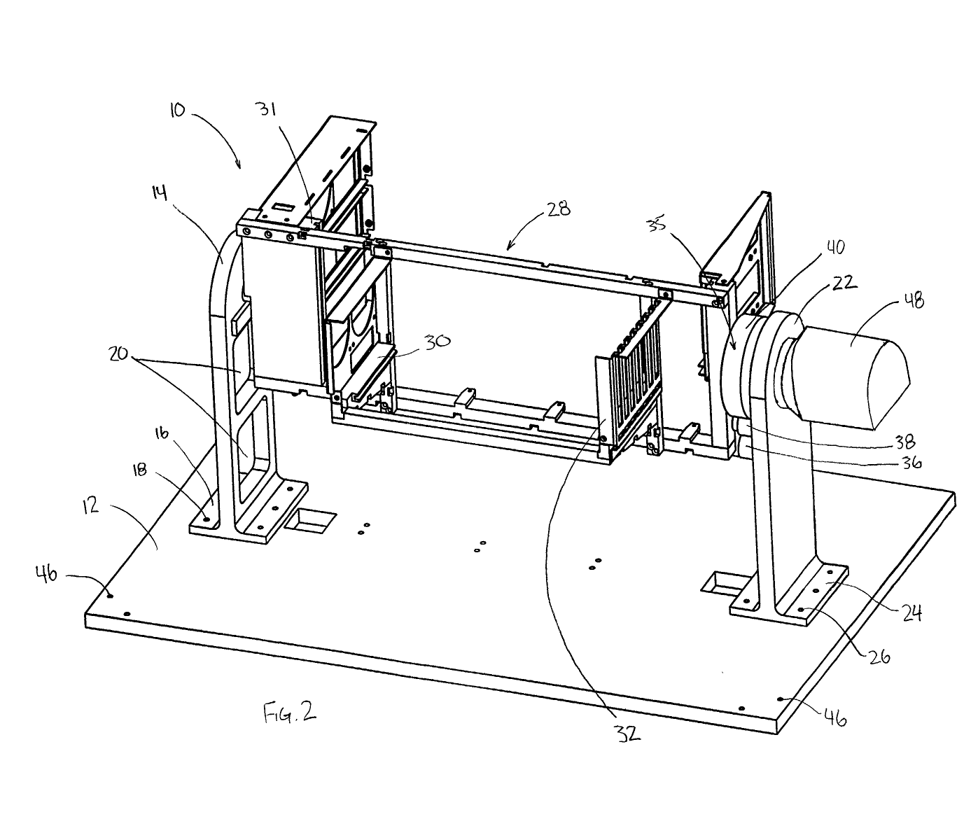

Alternate rotation mechanisms such as a stepper motor 48 can replace the crank handle 34, the locking aperture 42, and the associated pin 44, as shown in FIG. 2. A stepper motor 48 activates electronically to rotate the gear train 35, and typically holds or locks its position in place to prevent rotation when no electrical signal is instructing a clockwise or counterclockwise rotation.

FIG. 3 illustrates the test stand 10 with a motherboard 51, PCI I/O board 50, and PCI cards 52 installed. Additionally, a fan mount 54 is located on an opposite side of the support bracket 28 from the motherboard 51 and the PCI I/O board 50. This fan mount 54 supports a number of fans (not shown), which pull air across the back of the motherboard 51 and the PCI I/O board 50 for cooling. The first support arm 14 covers the fans in certain rotational positions, such as the one shown in FIG. 3. The first support arm therefore includes the airflow apertures 20 to allow air to flow through the first support arm 14, through the fans, and across the motherboard 51 and the PCI I/0 board 50. If the airflow apertures 20 were not located in the first support arm 14, the solid structure of the support arm 14 would partially block the intake to the fans, decreasing the airflow through the fans and thus the fan cooling power. If the support bracket 28 remained in the blocked position for an extended period, the fans may be unable to sufficiently cool the test subject computer hardware, thus causing malfunctions. The inclusion of the airflow apertures 20 substantially reduces the hindrance to the fan intake, preserving the desired cooling properties of the fan.

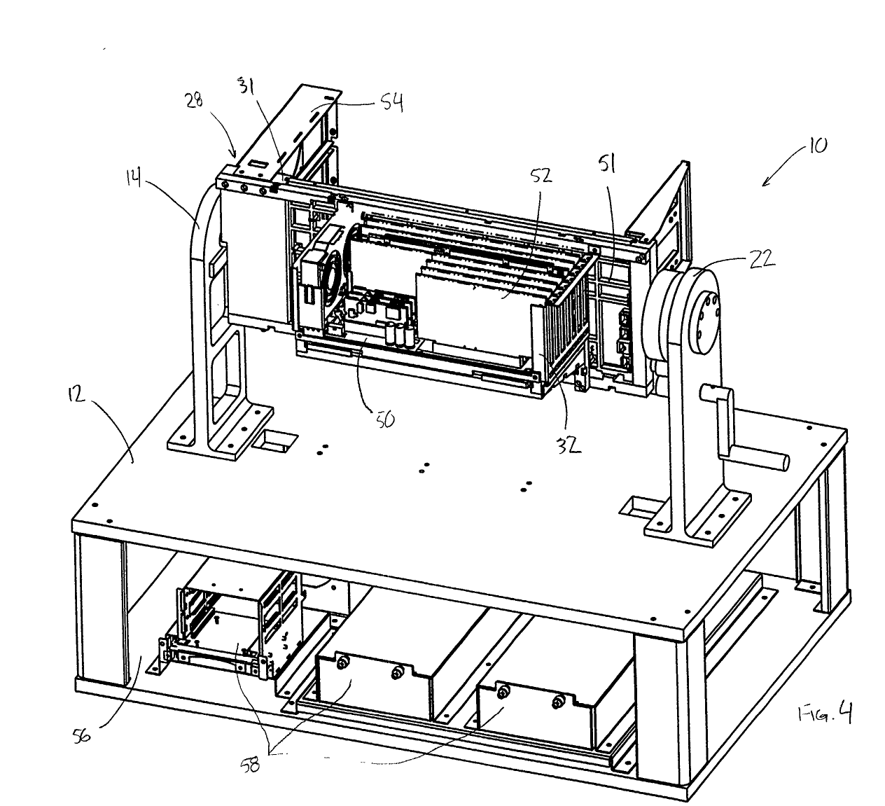

The base 12 can further include a sub-base 56 as illustrated in FIG. 4. The sub-base 56 can include a number of computer accessories 58, such as power supplies, memory, and hard drives. This enables easy connection from the computer accessories 58 to the motherboard 51 and PCI I/O board 50 on the above support bracket 28.

Numerous modifications and alternative embodiments of the invention will be apparent to those skilled in the art in view of the foregoing description. The locations of each of the main elements of the test stand 10, for example, can be alternatively arranged such that the crank 34, gear train 35, stepper motor 48 (i.e., rotational mechanisms) locking apertures 42 (i.e., locking mechanism), airflow apertures 20, and the like, can be on different support arms 14 and 22, and in different relative positions than the particular arrangement illustrated. Accordingly, this description is to be construed as illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

What is claimed is:

1. A test stand for testing computer hardware components, comprising:
a base;
a first support arm mounted to said base, said first support arm having a rotation mechanism mounted thereto;
a support bracket for supporting said computer hardware components, said support bracket being pivotally mounted to said first support arm and in communication with said rotation mechanism, such that said rotation mechanism controls the rotation of said support bracket through a predetermined degree range.

2. The test stand of claim 1, further comprising a second support arm mounted to said base.

3. The test stand of claim 2, wherein at least one of said first and second support arms comprises one or more apertures for enabling airflow therethrough;

4. The test stand of claim 1, wherein said base comprises a box for storing a selection of computer accessories.

5. The test stand of claim 1, wherein said rotation mechanism comprises a crank coupled with a gear train, such that rotation of said crank causes rotation of said support bracket about a pivot axis.

6. The test stand of claim 5, wherein said gear train comprises a first gear having a first predetermined number of gear teeth meshed with a second gear having a second predetermined number of gear teeth, said second gear further meshed with a third gear having a third predetermined number of gear teeth, said third gear being fixedly coupled with said support bracket.

7. The test stand of claim 6, wherein said first and second gears have a gear ratio of approximately one.

8. The test stand of claim 7, wherein said second and third gears have a gear ratio greater than one.

9. The test stand of claim 1, wherein said rotation mechanism further comprises a locking mechanism for locking said support bracket in a desired rotational position.

10. The test stand of claim 1, wherein said locking mechanism is a locking pin.

11. The test stand of claim 1, wherein said rotation mechanism comprises a stepper motor coupled with a gear train.

12. The test stand of claim 11, wherein said gear train is further coupled with said support bracket, such that activation of said stepper motor rotates said support bracket about a pivot axis.

13. The test stand of claim 1, wherein said support bracket is arranged to support a motherboard.

14. The test stand of claim 1, wherein said support bracket is arranged to additionally support at least one PCI I/O board.

15. The test stand of claim 1, wherein said predetermined degree range is approximately 180 degrees.

16. The test stand of claim 1, wherein said predetermined degree range is approximately 240 degrees.

17. The test stand of claim 1, wherein said predetermined degree range is approximately 360 degrees.

18. A rotation mechanism for a test stand apparatus, comprising:
a crank coupled with a gear train, said gear train mounted in a support arm and in rotational communication with a support bracket for supporting computer hardware components, such that said rotation mechanism controls the rotation of said support bracket through a predetermined degree range.

19. A method of supporting and manipulating computer hardware components being tested, comprising:
mounting said components into at least one bracket of said test stand apparatus;
positioning said components to enable probing and testing of said components; and
manipulating said at least one bracket within said test stand apparatus as desired to position and re-position said components for probing and testing purposes, wherein said manipulating includes rotating said at least one bracket with a rotating mechanism through a predetermined degree range.
